(19) United States
(12) Patent Application Publication
(10) Pub. No.: US 2022/0145500 A1
(43) Pub. Date: May 12, 2022

(54) APPARATUS FOR THE PRODUCTION OF NEEDLE PUNCHED NONWOVENS

(71) Applicant: ADLER PELZER HOLDING GMBH, Hagen (DE)

(72) Inventors: Siegfried BERNHARDT, Bremen (DE); Volkmar SCHULZE, Schierling (DE)

(73) Assignee: ADLER PELZER HOLDING GMBH, Hagen (DE)

(21) Appl. No.: 17/433,955

(22) PCT Filed: Feb. 18, 2020
(86) PCT No.: PCT/EP2020/054152

§ 371 Date: Aug. 25, 2021

(30) Foreign Application Priority Data
Feb. 26, 2019 (DE) 10 2019 104 851.6

(51) Int. Cl. D01G 15/46; B32B 19/06; B32B 5/02; B32B 5/06; B32B 5/08; B32B 5/26; D04H 1/498; D04H 1/559

(52) U.S. Cl. CPC D01G 15/46; B32B 2307/718; B32B 5/022; B32B 5/06; B32B 5/08; B32B 5/26; D04H 1/498; D04H 1/559; B32B 2250/05; B32B 2250/20; B32B 2262/0246; B32B 2262/0253; B32B 2262/0284; B32B 2262/101; B32B 2262/12; B32B 2262/14; B32B 2307/10; B32B 19/06

(57) ABSTRACT

An apparatus for the production of needle punched nonwovens makes it possible to introduce different materials via the nonwoven thickness and/or nonwoven width into the individual layers during their production.

The object of the invention is an apparatus for the production of needle punched nonwovens which makes it possible to introduce identical and different materials via the nonwoven thickness and/or nonwoven width into the respective individual layers of a multi-ply nonwoven individually already during their production.

In particular, PP/PET, PP/BiCo, PP/BiCo/PET and PET/BiCo mixed fibre nonwovens in the grammage range from 400 to 1800 g/m² are used as base nonwovens, the application of which is to be seen in particular in the exterior area of motor vehicles.

In the prior art, processes for the production of velour carpets are known; see, among others, DE 44 09 771 A1, DE 29 00 935 C2 and DE 10 2008 026 968 A1.

Card or carding machines for fibre web production are described, for example, in US 2018/0051400 A1, WO 2017/178148 A1, US 2016/0362818 A1, DE 10 2015 112 777 A1 and DE 10 2014 009 339 A1. Specifically concerning nonwoven lay-up devices, embodiments can be found in U.S. Pat. No. 3,903,569, DE 10 2010 050 027 A1 and DE 20 2012 102 597 U1.

In addition, processes for the production of so-called recycled sandwich nonwovens or components are described in the prior art, in which on the one hand the pressing technology (DE 10 2016 202 290 A1) and on the other hand the needling (DE 10 2013 222 403 A1, DE 10 2016 203 348 A1) are used.

WO 2012/052535 A1 relates to a method for producing a composite nonwoven in a continuous process sequence and to an apparatus for carrying out the method. In this process, a fibre web is formed from a fibre stream by a carding device, on the surface of which a nonwoven layer of synthetic fibres is subsequently laid. For this purpose, the fibre web is guided within a suction zone on a delivery belt to a melt-blowing device, in which the synthetic fibres are laid by melt-blowing on the surface of the fibre web. The fibre web covered with the nonwoven is then laid in several layers by a nonwoven lay-up device to form the composite nonwoven.

No processes or devices are known from the prior art that describe an interspersion of the same or different materials into the individual layers of a multilayer nonwoven during its production.

The task of the present invention in comparison with the aforementioned prior art is thus to provide an apparatus for the production of nonwovens, which makes it possible to intersperse identical or different materials and/or quantities as ground material and/or fibres and/or flakes and/or powder into the respective individual layers already during the production of the nonwoven over the thickness and/or width of the nonwoven and to needle the composite obtained after the laying of the nonwoven.

In a first embodiment, the object of the present invention is an apparatus for producing multi-layer needle punched nonwovens with the same or different materials over the nonwoven thickness and/or nonwoven width of the respective individual layers, which is characterised in that

it has interspersing devices 4, 5, 6, 7 for applying the materials to at least one or more unneedled or needle-punched fibre web layer(s) 1, 2, one or more of the interspersing devices 4, 5, 6, 7 being located between pickup conveyor belts 11, 12 of a card 10.

With the aid of the apparatus according to the invention, it is possible, in accordance with the in particular acoustic and mechanical requirements, for example of a textile wheel arch liner, to intersperse the same or different materials and quantities as ground material and/or fibres and/or flakes and/or powder between the fibre webs 1, 2, the possible connection and/or control of the interspersing devices 4, 5, 6, 7 being effected in accordance with the required material types and/or material quantities,

to lay the fibre webs 1,2 with the materials in between to form a single layer 3, lay the individual layers 3 into a multiple layer 9 to form a material composite 8 and to needle the material composite 8.

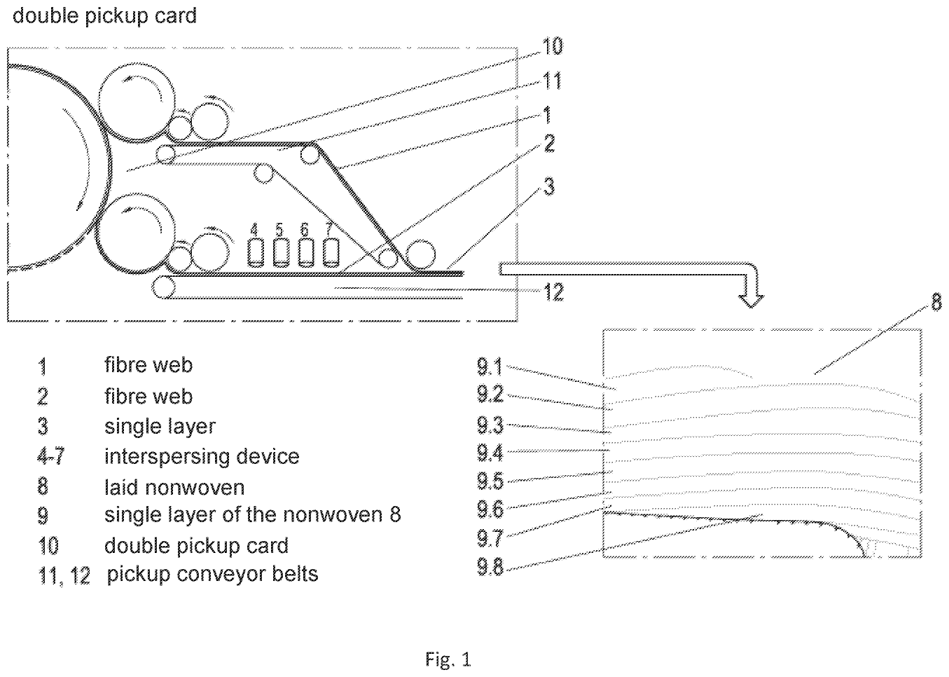

In a preferred embodiment, the apparatus comprises a double pickup carding machine 10 (FIG. 1), in which the interspersing devices 4, 5, 6, 7 are arranged between the two pickup conveyor belts 11, 12 and can be controlled and/or switched on differently here.

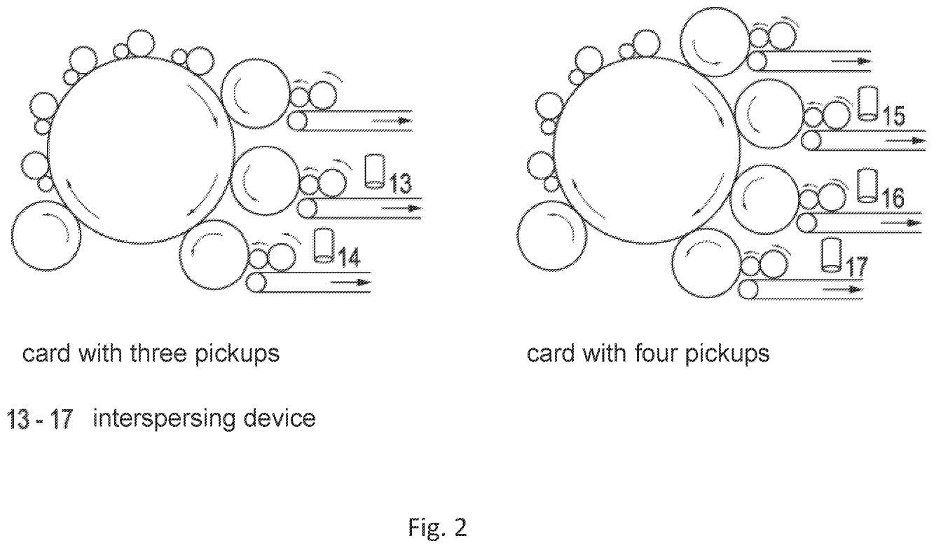

FIG. 2 shows a multi-pickup card with the corresponding interspersing devices 13, 14 and 15, 16, 17.

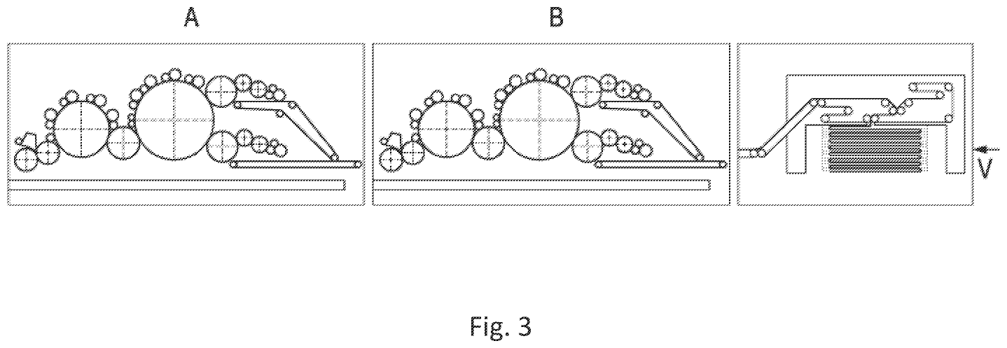

In FIG. 3, 2 cards are arranged one behind the other and the layers then are transferred to a lay-up device. This allows a good reciprocity and variability of the materials to be interspersed. With this arrangement, different base nonwoven qualities can also be realised by selective choice of the individual layers.

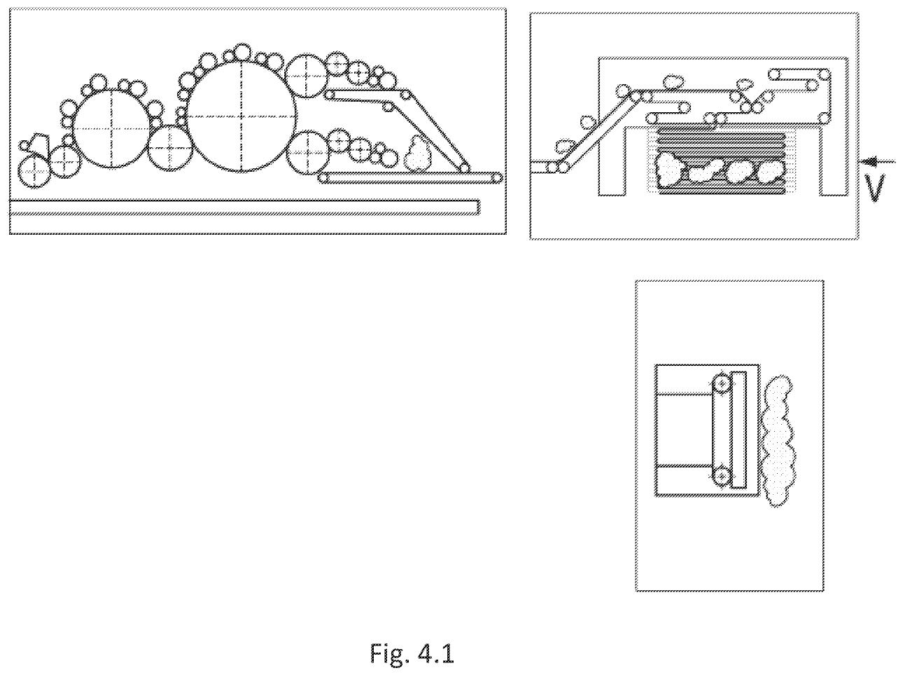

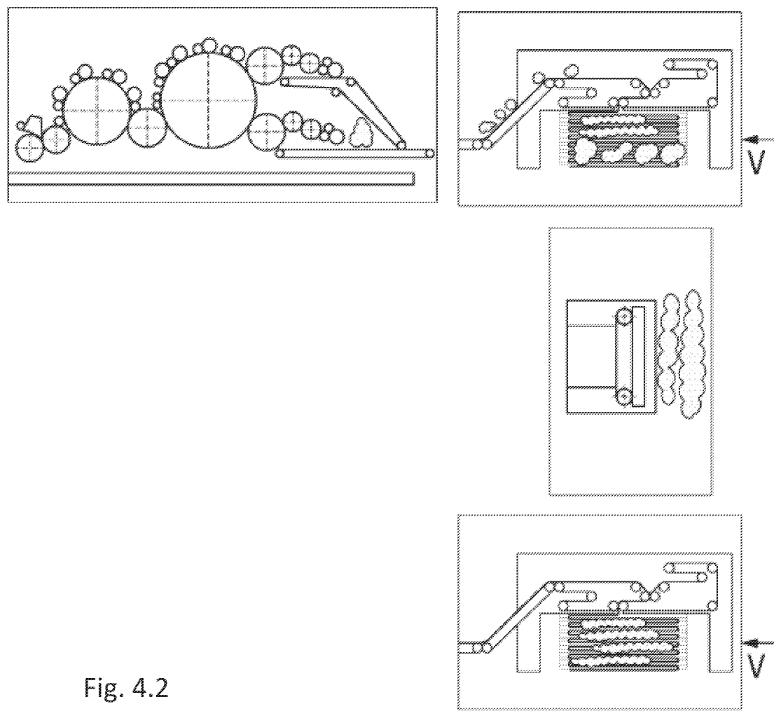

FIG. 4 shows the arrangement of 2 cards and 2 lay-up devices arranged next to each other. The advantage of this arrangement is that the same or different interspersing materials can be used with regard to the number of layers per lay-up device and thus at the top or bottom. The distribution of the interspersing material and thus the variation of the weight ranges is given.

The core of the present invention is thus the provision of an apparatus which makes it possible to intersperse and needle the same or different materials and/or quantities as regrind and/or fibres and/or flakes and/or powder between fibre webs in a card depending on the acoustic and mechanical requirements of the component to be produced from the nonwoven.

The apparatus according to the invention thus enables interspersing as required by arranging interspersing devices 4, 5, 6, 7 between the pickups of a card and controlling them.

The advantage of the present invention lies in the provision of deformation-appropriate/stable nonwovens in which property-influencing layer structures can already be produced during their manufacture via the thickness and/or width of the respective individual layers. This eliminates the need for laminating, sewing and the like of individual layers during the production of components, as well as the time-consuming changing of rolls or blanks; laminating systems are no longer required and this is associated in particular with a reduction in cycle time.

### Example of Execution

For the production of a deformation-resistant/stable nonwoven comprising 8 individual layers with a total weight of 1600 g/m² for the manufacture of textile wheel arch liners, 150 g/m² glass fibre/panox/PET/BiCo ground material is incorporated into a first layer—later facing the wheel—and 150 g/m² PP/PET/BiCo ground material is incorporated into a second layer following the first layer, 150 g/m² of PP/PET/BiCo ground material into a second layer following the first, and 150 g/m² of glass fibre/Panox/PET/BiCo ground material into the outer eighth layer, which will later face the body, and 150 g/m² of mineral and glass fibre ground material into the seventh layer underneath. The base nonwoven consists of a commercially available 40 wt. % PP and 60 wt. % PET fibre.

An apparatus according to the invention with the interspersing devices as described above is used for this purpose.

The fleece was then formed into wheel arch shells using standard methods [contact heating field (T=200° C.; t=50 sec; gap width=4 mm), tool (T=20° C.; t=50 sec; gap width=3.5 mm)].

The wheel arch liner has improved behaviour in terms of stiffness, temperature resistance and flammability due to the interspersed and needled materials.

1. Apparatus for the production of multilayer needle punched nonwovens with the same or different materials and quantities over the nonwoven thickness and/or nonwoven width of the respective individual layers, comprising
interspersing devices (4, 5, 6, 7) for applying the materials to at least one or more unneedled or needled fibre web layer(s) (1, 2), one or more of the interspersing devices (4, 5, 6, 7) being located between pickup conveyor belts (11, 12) of a card (10).

2. The apparatus according to claim 1, comprising a card (10) with two, three or four pickups.

3. The apparatus according to claim 1, comprising two cards (10) arranged one behind the other, wherein the layers can be laid down on a lay-up device.

4. The apparatus according to claim 1, comprising two cards (10) and two lay-up devices arranged side by side.

5. The apparatus according to claim 1, comprising controllable and/or switchable interspersing devices (4, 5, 6, 7) between two pickup conveyor belts (11, 12).

6. The apparatus according to claim 2, comprising two cards (10) arranged one behind the other, wherein the layers can be laid down on a lay-up device.

7. The apparatus according to claim 6, comprising controllable and/or switchable interspersing devices (4, 5, 6, 7) between two pickup conveyor belts (11, 12).

8. The apparatus according to claim 2, comprising two cards (10) and two lay-up devices arranged side by side.

9. The apparatus according to claim 8, comprising controllable and/or switchable interspersing devices (4, 5, 6, 7) between two pickup conveyor belts (11, 12).

10. The apparatus according to claim 2, comprising controllable and/or switchable interspersing devices (4, 5, 6, 7) between two pickup conveyor belts (11, 12).
